(19) United States
(12) Patent Application Publication
(10) Pub. No.: US 2008/0126595 A1
(43) Pub. Date: May 29, 2008

(54) ONE BUTTON SAFE DISCONNECT OF USB DEVICES

(75) Inventors: Scott Davis, College Station, TX (US); Craig Trump, Houston, TX (US); E. David Neufeld, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/468,101

(22) Filed: Aug. 29, 2006

(51) Int. Cl. G06F 3/00

(52) U.S. Cl. 710/19

(57) ABSTRACT

Methods, systems, and apparatus for a one button disconnect of USB devices. One exemplary embodiment includes a method for safely disconnecting a peripheral device removably connected to a computing system. The method includes signaling an Operating System, through a peripheral communication bus, that peripheral device disconnection is desired; quiescing device driver activities; and disconnecting the signaling device from the computer system.

### BACKGROUND OF THE INVENTION

Devices which are particularly known in the industry for performing sustained communication sequences comprises Mass Storage Devices and Printers. Some examples of Mass Storage Devices include tape drives, and disk drives, Compact Disk/Digital Video Disk (CD/DVD) Drives, and Flash/thumb/key/jump/Universal Serial Bus (USB) drives.

If the operating system is performing a sustained communication sequence with a device, such as saving a file to a mass storage device, or printing a document to a printer, and the device is disconnected, the communication sequence is interrupted. If a file was being read from the device by an application, then removal of the device would cause the read to fail, and possibly result in the application becoming unstable. In the case of a printer, the job being printed would be incomplete, and/or the printer could become confused requiring a reset. In the case of a mass storage device, like a USB drive, interrupting the communications sequence could result in corrupted files and unrecoverable data errors. This can happen often due to an operating system's procedures for buffering Input/Output (I/O) and allowing slower devices to complete transfers in a background process. If a system is very active, then buffered communications may be prolonged past the normally expected completion time.

Some operating systems, such as Linux, give the user a way to ensure I/O buffers have been flushed prior to removal of the device by requiring you to perform an “unmount” or similar command. This command causes any buffers associated with the device to be flushed. Once this is done the device can safely be removed. However this requires knowing exactly where the device in question is mounted. Other operating systems, like Windows, require the user to go through a series of steps involving clicking on an icon in the system tray and choosing to stop the device to be removed to ensure safe removal of the device. This can be a problem if there are multiple devices because the operating system decides how to label a device when it is inserted, so the user may not know the exact designation of the device to be removed. Stopping the wrong device can result in extra steps being required before the device is restarted and returned to operating condition.

### BRIEF SUMMARY OF THE INVENTION

A peripheral device is designed to facilitate proper disconnection from a system by a user. By giving the user a method to send a signal to the device driver or operating system prior to disconnecting the device, a user can ensure the software is aware of the pending device removal and is quiescent prior to said removal. Since device driver activity ceases prior to removal, data will not be corrupted or lost due to the interruption of transfer activities by a device removal.

### BRIEF DESCRIPTION OF THE DRAWINGS

FIG. 1 is a Top Side View of a USB device plug in accordance with an exemplary embodiment of the invention.

FIG. 2 is an End View of a USB device plug in accordance with an exemplary embodiment of the invention.

FIG. 3 is a Top Side View of a Latching mechanism for a USB device plug in accordance with an exemplary embodiment of the invention.

FIG. 4 is a Top Side View of a Latching mechanism for a USB device plug in accordance with an exemplary embodiment of the invention.

FIG. 5 is a flowchart of safe disconnect procedures for a USB device in accordance with an exemplary embodiment of the invention.

FIG. 6 is a flowchart of optional device driver unloading procedures for a USB device in accordance with an exemplary embodiment of the invention.

FIG. 7 is a flowchart of optional device port unlocking procedures for a USB device port in accordance with an exemplary embodiment of the invention.

FIG. 8 is a diagram of a conventional peripheral interface in accordance with an exemplary embodiment of the invention

FIG. 9 is a diagram of a sophisticated peripheral interface in accordance with an exemplary embodiment of the invention.

### DETAILED DESCRIPTION OF THE PREFERRED EMBODIMENTS

The present invention relates generally to peripheral devices which are removably connected to a computer system and more particularly to devices which preformed prolonged communications as opposed to those which send short burst of information across the bus.

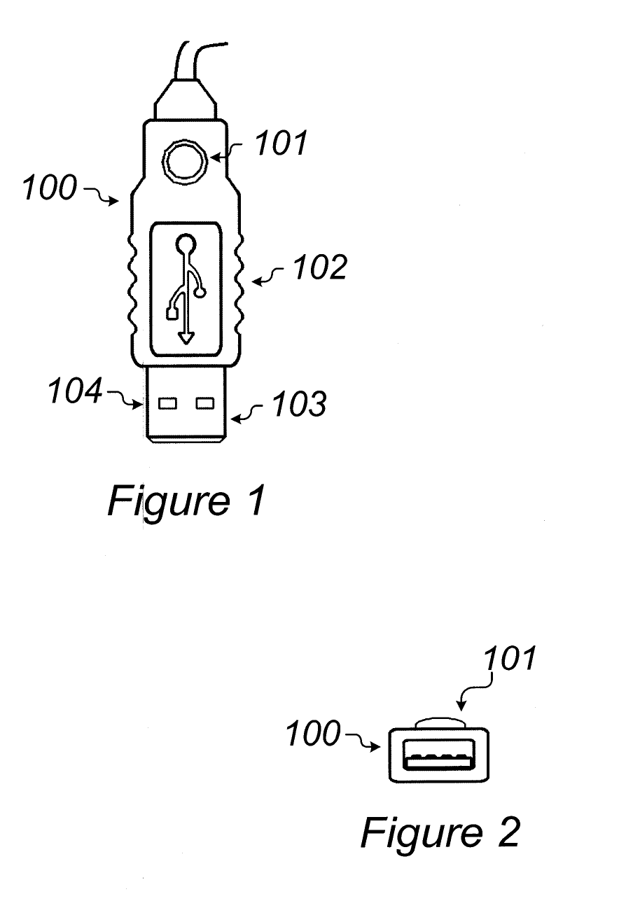

FIGS. 1 & 2 illustrates a USB peripheral device plug. Some peripheral devices are small enough to be completely contained within the plug housing. Some peripheral devices are larger and must include a wire with a plug to connect to the peripheral port so as not to have the peripheral port support the device's weight. In any of these scenarios there are standard parts which are included in the plug; these include the electrical connection interface (103), the body of the plug or device (100) and usually some sort of gripping aid or indicator such as the ridges illustrated by (102). In the preferred implementation an additional component has been added in the form of a lighted push-type button (101) which acts as a user interface to send a signal that a user desires disconnection of the device. The lighted portion of the button will then change state indicating to the user that disconnection may safely be preformed. The button and lighted indicator may be separate components, and other user interface devices may be employed to take an input and deliver an output to the user instead of a lighted push-type button. The preferred embodiment includes the user interface device in the plug of the peripheral device. In another embodiment, the user interface can be located anywhere on the peripheral device. In another embodiment, the user interface can be located on the computing device provided the input device is uniquely associated with a specific removable peripheral connection.

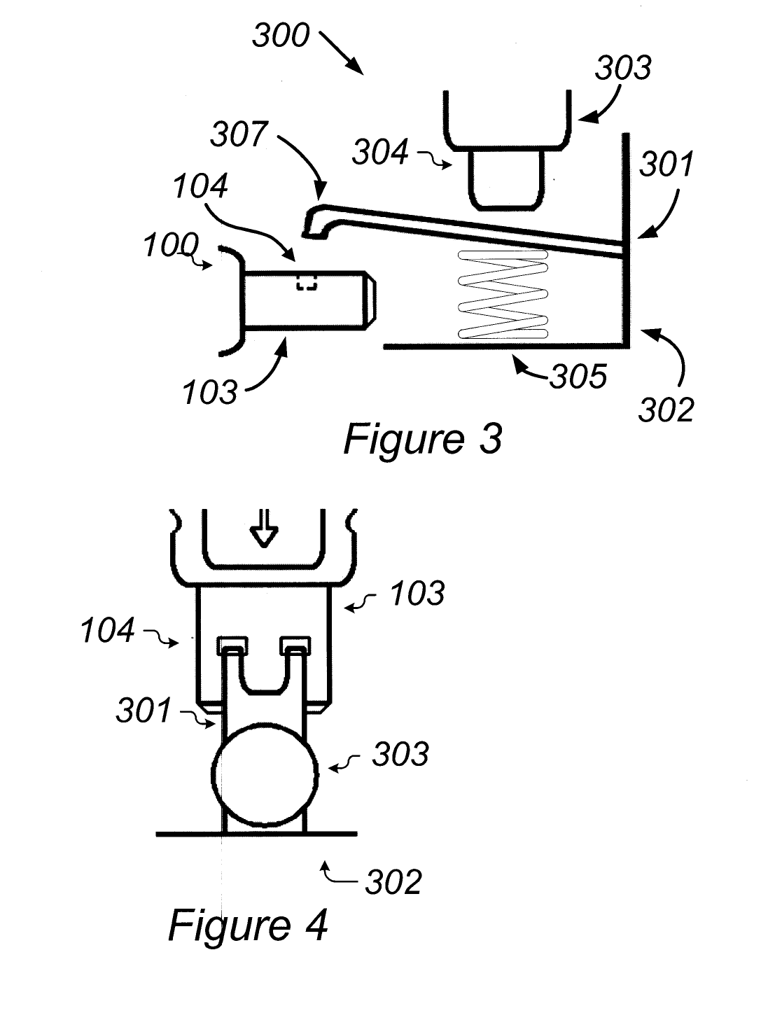

In another embodiment, physical security may be included to prevent premature removal of the peripheral device. FIGS. 3 & 4 show a latching mechanism (300) comprising a latch plate (301) having one end movably attached to the computing device (302) and an opposite end formed into a catch to engage square voids (104) in the electrical interface connection (103) of the USB plug. The latch plate (301) is connected to the computing device at one end such that the end comprising the catches (307) pivots or flexes between an engaged and disengaged position. In the engaged position the latch plate physically engages the USB device such that the device may not be disconnected from the computing device. In the disengaged position the latch plate disengages from the USB device such that the device may be disconnected from the computing device.

In one embodiment the latch plate is immovably attached to the computing device at one end, and is constructed in manner so as to be flexible between an engaged and disengaged position. In the preferred embodiment the latch plate is movably attached to the computing device such that the latching plate may pivot between an engaged and disengaged position. In an alternative embodiment the latch plate is attached to the computing device by a pivoting connection in the center of the latching plate such that it can pivot between the engaged and disengaged positions.

In the preferred embodiment, an end of the latching plate is formed into two catches (307) which engage the square voids (104) in the electrical interface connection (103). In other embodiments the catch may engage a lip or grove incorporated into the USB device. In other embodiments there may be multiple latching plates which clasp the USB device from multiple directions.

In other embodiment, the latching plate(s) is/are biased such that they remain in a disengaged position until acted upon by a force which causes the latching plates to move into an engaged position. Alternatively, they may be biased to remain in the engaged position until acted upon by a force which causes the latching plates to move into a disengaged position. In the preferred embodiment the latching plate (301) is biased with a spring (305) to hold it in a disengaged position. A solenoid (303) is positioned such that when the plunger (304) exerts a force on the latching plate (301) the springs force is overcome such that the resulting net force causes the latching plate to move into an engaged position. The latching plate is held in the engaged position until the solenoid (303) retracts the plunger (304) allowing the force of the spring (305) to return the latching plate to a disengaged position. In another embodiment the spring is used to bias the latching plate into an engaged position and the solenoid is used to overcome the spring force to move the latching plate into a disengaged position.

In one embodiment the latching plate may be mounted on a servo motor, or other device capable of moving and holding both the engaged and disengaged positions without the aid of a biasing device. In one embodiment the catches (307) are mounted on the plunger (304) of the solenoid (303), and the solenoid is positioned such that it can directly move catches (307) between an engaged and disengaged position.

A peripheral device sends a signal to the operating system requesting driver activity quiescence so the signaling device can be disconnected from the system bus without compromising data integrity. A user will then be able to disconnect a device from a system while allowing the operating system to maintain the integrity of the data involved without having to navigate the operating system control system to identify the correct device and request driver activity quiescence. The result is a quicker and less confusing method for the user to safely disconnect a device on a machine with multiple similar devices.

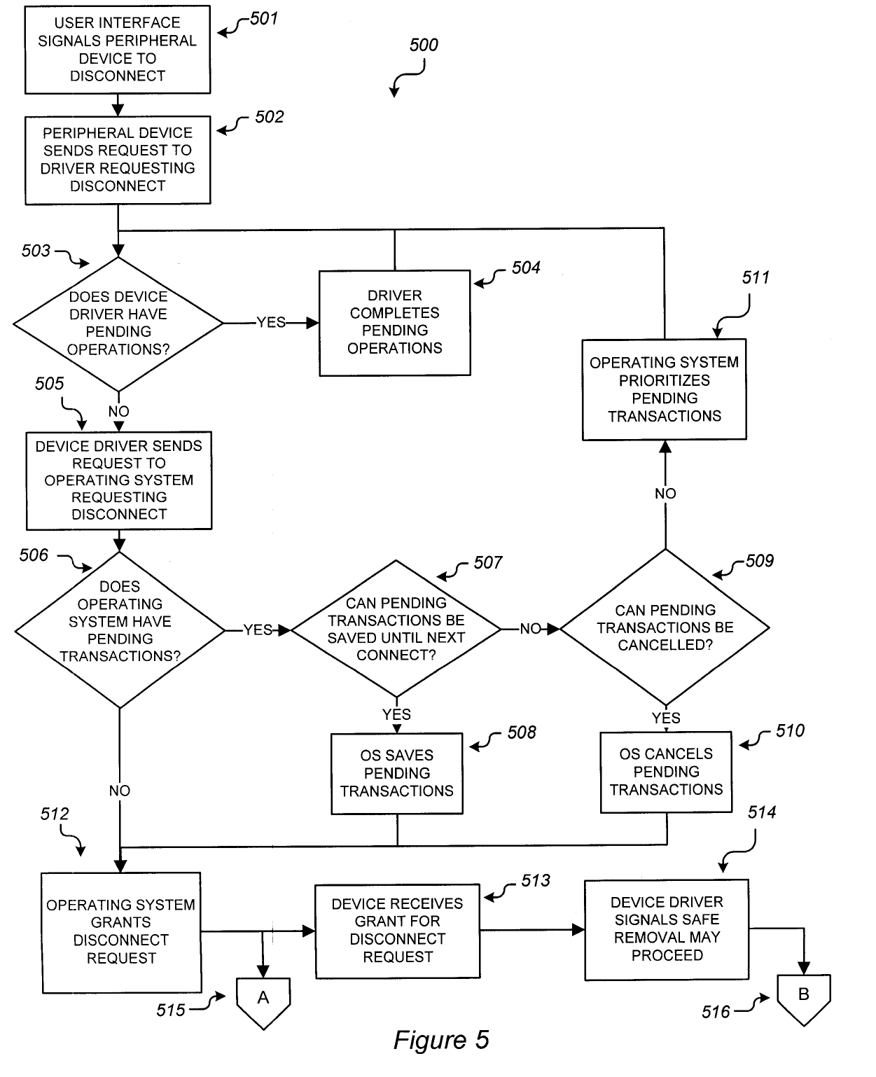

FIG. 5 shows a flowchart which illustrates operation of an exemplary embodiment of the invention. The process is started when a user operates a push-type button (101). When activated, the User interface signals the peripheral device to disconnect (501). In the preferred embodiment, this signal is a switch closing which is detected by the microprocessor or other electronic circuit, in the USB device, which allows the peripheral device to be capable of the buffering operations. In peripheral devices which do not contain this level of circuitry the switch would trigger an interrupt signal to be detected by the device driver of the port. Once the Peripheral device sends the request to the driver (502), the driver will begin quiescence by completing any pending operations. (503, 504). Once the driver has completed all pending operations, it will notify the Operating System (OS) of the pending device disconnection (505). The OS will then determine if it has pending operations which can be stored until next connection (506, 507, 508), or if the pending operations can be cancelled (506, 507, 509, 510), or if the pending operations must be completed prior to disconnect (506, 507, 509, 511). Pending operations which must be completed prior to disconnect will result in new operations for the device driver to handle (503). Once the device driver has completed all pending transactions, and the OS has handled all pending transactions, the OS will grant the disconnect request (512). Once the Device receives the grant for disconnect request (513), it will signal that it is safe to remove the device (514). This signal in the preferred embodiment involves turning off the light on the lighted push-type button (101). In an alternative embodiment a light may change from red to green showing the device may be removed. Devices with sound capability may signal the user with a tone, instead of or in addition to the light signal described above.

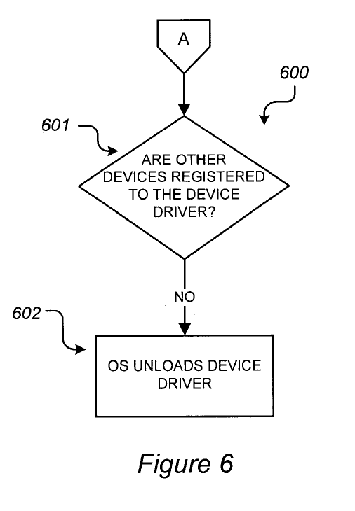

In one embodiment, the OS may have multiple devices associated with a single driver. In this instance, illustrated in FIG. 6, the OS would need to determine if there are other devices still registered to the driver (601), and only unloads the driver from memory (602) in the event all devices utilizing the driver have been removed from the system. (601)

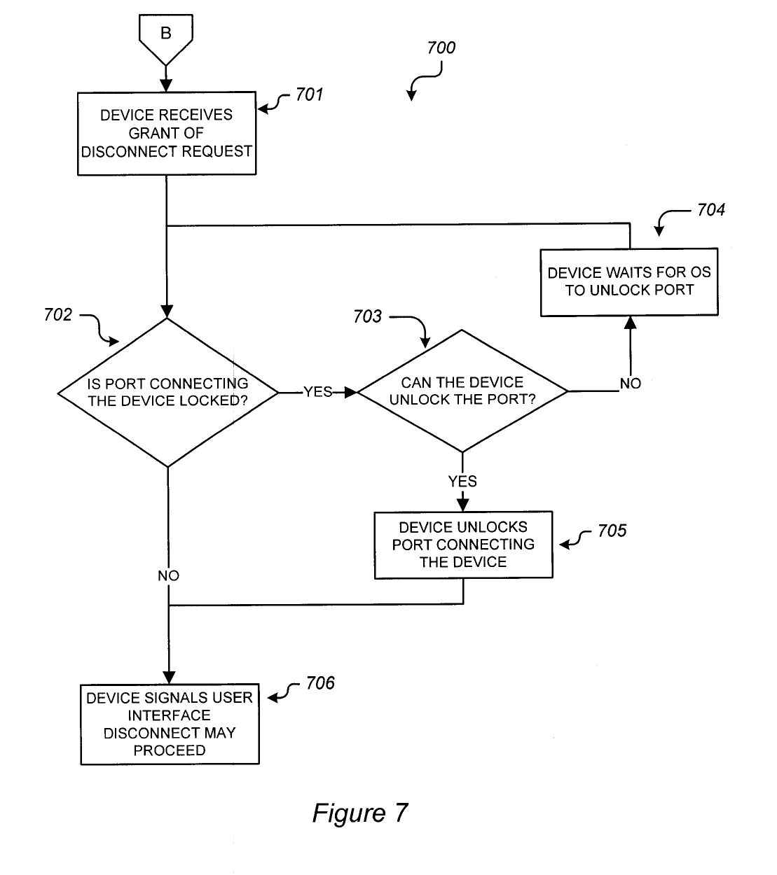

FIG. 7 illustrates an exemplary flow diagram (700) of operation of the locking mechanism if employed in a peripheral device. The locking mechanism would be engaged upon driver loading. Upon receiving the grant of the disconnect request (701) the port would unlock the device directly (705) or pass the request along to the driver of the port controlling the lock of the device (704). Once the device has been unlocked, the device driver may be signaled that the device can be removed (706).

Signals described above may be sent as a message in a device which uses a packet transmission method to communicate with the driver. The signals may also be a series of unique line levels or sequences which are intercepted and interpreted by the driver.

Quiescence of device activity may include, but is not limited to one or more of the following: Notifying the User of a request to remove the device; updating all queued information to and from the device, identifying and notifying other applications which may be accessing the device; flushing all cached buffers and/or delayed write buffers; ceasing all communication with the device; powering down the device or port; updating system configurations and/or statistics; and possibly unloading the drivers for the device.

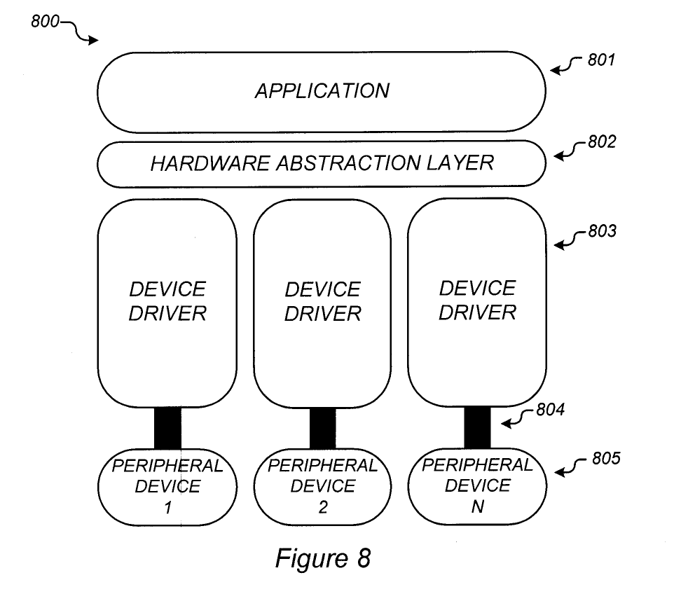

FIG. 8 illustrates a an exemplary flow diagram (800) of a simple peripheral interface. Applications (801) communicate, through a Hardware Abstraction Layer (HAL) (802), to access a plurality of device drivers (803) which, in turn, directly communicate through the Communications Bus (804) to the Peripheral Devices (805). Drivers, operating in this scenario, can be unloaded from a system's memory when the peripheral device is no longer connected to the system. The procedure of unloading device drivers, which are no longer serving a current need in a system, frees system resources for other system needs.

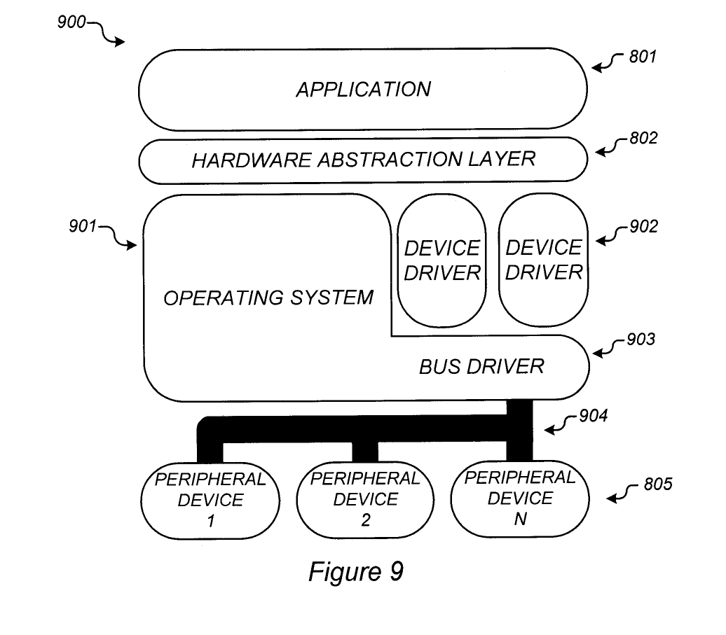

FIG. 9 illustrates an exemplary flow diagram (900) of a sophisticated peripheral interface. Applications (801) communicate, through a Hardware Abstraction Layer (HAL)

(802), to access a plurality of device drivers (902) which communicate with peripheral devices (805) by passing communications through a bus driver (903) which controls a common communication bus (904). A device driver (903), operating in this scenario, can be associated with multiple peripheral devices (805) and can not be unloaded from a system's memory until all peripheral devices (805) utilizing the device driver's (903) services have been disconnected. So each device driver (903) disconnection triggers a test to determine if there are any other peripheral devices (805) using the device driver's services, and when none are found, the device driver may be unloaded from a system's memory.

In some implementations of the current invention, a locking mechanism may be employed on the physical bus connector or device bay which prevents the removal of the device until the operating system has finished device quiescence. Such locks may include a physical override which allows the user to force removal of the device without waiting for the operating system to disengage the lock.

One implementation of the current invention, the EJECT_REQ signal may be sent in response to a user operating a mechanism on the physical device to be removed. The mechanism may be a button conveniently located on the plug housing, where the cable connects to the computer or on the main device housing. The mechanism may be an eject button or lever located on a disk drive or tape cartridge drive.

In one implementation of the current invention the EJECT_REQ signal may be sent in response to activation of an inner-lock preventing the physical removal of the device from a carriage, slot, or other type of holder.

In one implementation of the current invention the EJECT_REQ signal may be sent by the device without intervention by the user. As a security measure, a device may include an internal clock which triggers a EJECT_REQ signal followed by a power down of the device rendering it unusable during certain timeframes. A driver may be configured such that Quiescence does not flush buffers, but instead preserves them in another manner such that upon device reactivation the state can be resumed.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for safely disconnecting a peripheral device removably connected to a computing system comprising:
signaling an Operating System (OS), through a peripheral communication bus, that peripheral device disconnection is desired;
quiescing device driver activities; and
disconnecting said signaling device from said computing system.

2. The method of claim 1 further comprising activating an input device located on the peripheral device.

3. The method of claim 2 wherein, said input device comprises a push-type button.

4. The method of claim 2 wherein, said input device comprises a lighted push-type button.

5. The method of claim 1 further comprising:
providing a visual indication on the peripheral device to indicate when the peripheral device can be disconnected from the computing system.

6. The method of claim 1 wherein step of signaling OS comprises activating an input device on the computing system associated with a specific communications bus connection point.

7. The method of claim 6 wherein, said input device comprises a push-type button.

8. The method of claim 6 wherein, said input device comprises a lighted push-type button.

9. The method of claim 8 wherein the step of signaling device may be disconnected comprises changing state of said lighted push-type button.

10. The method of claim 1 wherein quiescing device driver activities comprises
device driver for said peripheral device:
completing pending operations;
signaling OS kernel device disconnection is desired;
receiving from OS kernel signal device may safely be removed; and
signaling device disconnection; and
OS kernel:
receiving from device driver signal device disconnection is desired;
saving pending transactions which can be saved until next connect;
canceling pending transactions which can be cancelled;
prioritizing pending transactions which can not be cancelled; and
signaling device driver disconnection.

11. An apparatus for safely disconnecting a peripheral device removably connected to a computing system comprising:
a computing system;
a peripheral device electrically connected to said computing system;
said peripheral device comprising:
an input device electrically connected to said peripheral device; and
a means of sending a signal to said computing system, in response to activation of said input device requesting safe removal of device from system.

12. An apparatus as in claim 11, said peripheral device further comprising:
a status indicator;
a means of receiving a signal from computing system indicating device may be safely removed from the system.

13. An apparatus as in claim 12, wherein said peripheral device is connected to said computing system by a locking connector.

14. An apparatus as in claim 13, wherein said locking connector is unlocked when the signal is received from the computing system indicating the device may be safely removed from the system.

15. An apparatus comprising:
a peripheral device;
a computing system comprising:
a connector for electrically connecting said peripheral device; and
an input device associated with said connector; and
a means of safely disconnecting said peripheral device in response to activation of said input device.

16. An apparatus as in claim 15, said computing system further comprising:
a means of indicating when said peripheral device may be safely removed from system.

17. An apparatus as in claim 16, wherein said peripheral device is connected to said computing system by a locking connector.
